(19) United States
(12) Patent Application Publication
(10) Pub. No.: US 2026/0335850 A1
(43) Pub. Date: Oct. 29, 2026

(54) SYSTEMS AND METHODS FOR CONTINUOUS FUEL ADDITION

(71) Applicant: Found Energy Co, Boston, MA (US)

(72) Inventors: Luis Franco Carbajal, Cambridge, MA (US); Nicholas Craig, Woburn, MA (US); Peter Godart, Cambridge, MA (US); Ariel Jackson, Medford, MA (US); Jessica Lowe, Somerville, MA (US); Colin O'Shea, Somerville, MA (US)

(21) Appl. No.: 19/485,748

(22) PCT Filed: May 17, 2024
(86) PCT No.: PCT/US2024/029889

§ 371 Date: Nov. 19, 2025

Related U.S. Application Data
(60) Provisional application No. 63/503,428, filed on May 19, 2023.
(60) Provisional application No. 63/644,817, filed on May 9, 2024.

(51) Int. Cl. B01J 8/00; B01J 4/00; B01J 8/02; C01B 3/08

(52) U.S. Cl. CPC B01J 8/002; B01J 4/007; B01J 4/008; B01J 8/001; B01J 8/0278; C01B 3/08; B01J 2204/002; B01J 2208/00539; B01J 2208/00637; B01J 2208/00752

(57) ABSTRACT

Embodiments described herein relate to continuous aluminum-water reactor systems, methods, and associated devices for reacting aluminum fuel with water to produce thermal energy. A fuel loading apparatus may include a transfer tube including a transfer tube first end, a transfer tube second end, and a transfer tube wall therebetween defining a transfer tube passageway. The fuel loading apparatus also includes a reactor port extending radially from the transfer tube wall having a reactor port cavity disposed through the reactor port and the transfer tube wall into the transfer tube passageway.

### CROSS REFERENCE TO RELATED APPLICATIONS

This application claims the benefit of and priority to U.S. Provisional Patent Application No. 63/503,428, filed on May 19, 2023; and U.S. Provisional Patent Application No. 63/644,817, filed on May 9, 2024, the disclosure of each of which is hereby incorporated by reference in its entirety for all purposes

### TECHNICAL FIELD

Fuel loading apparatuses, where the freedom of movement is axial translation within the transfer tube or relative to the ports thereof, rotational movement relative to the transfer tube or relative to the ports thereof, or a combination of axial translation and rotational movement relative to the transfer tube or relative to the ports thereof. The present disclosure relates to devices, systems, and methods for continuous addition of fuel into a reactor. Specifically, the disclosure is related to the methods and apparatuses configured to continuously add fuel to aluminum-water reactors.

### BACKGROUND

Aluminum is a promising candidate for energy storage due to its high energy density, abundance, low cost, non-toxicity, non-volatility, and non-reactivity in storage. One method of extracting the energy from aluminum is to react the aluminum with water to form hydrogen and heat as described in Reaction 1 or Reaction 2.

Al+2 H₂O→1.5 H₂+AlO(OH)+Q_{reaction} (Reaction 1)

Al+3 H₂O→1.5 H₂+Al(OH)+Q_{reaction} (Reaction 2)

### BRIEF SUMMARY

In one aspect, a fuel loading apparatus includes a transfer tube including a transfer tube first end, a transfer tube second end, and a transfer tube wall therebetween defining a transfer tube passageway. The fuel loading apparatus also includes a fuel inlet port in fluid communication with the transfer tube passageway. The fuel loading apparatus also includes a vacuum port in fluid communication with the transfer tube passageway. The fuel loading apparatus also includes a reactor port in fluid communication with the transfer tube passageway. The fuel loading apparatus also includes a fuel carriage disposed within the transfer tube passageway includes a carriage body having an outer carriage surface, an inner carriage cavity, and a carriage wall therebetween, a first sealing member is disposed around the outer carriage surface and configured to form a first seal between the outer carriage surface and an inner surface of the transfer tube passageway, a second sealing member disposed around the outer carriage surface and configured to form a second seal between the outer carriage surface and the inner surface of the transfer tube passageway, and a first carriage aperture through the carriage wall and positioned between the first sealing member and the second sealing member creating fluid communication between the carriage cavity and the transfer tube passageway. In some embodiments, the fuel loading apparatus also includes a third sealing member disposed around the outer carriage surface and configured to form a third seal between the outer carriage surface and the inner surface of the transfer tube passageway, and a fourth sealing member disposed around the outer carriage surface and configured to form a fourth seal between the outer carriage surface and the inner surface of the transfer tube passageway, where the first carriage aperture is positioned between the third sealing member and the fourth sealing member. The fuel loading apparatus may also include where the vacuum port is coupled to a pump configured to evacuate air within a carriage cavity when the first carriage aperture is facing said vacuum port. The fuel loading apparatus may also include where the reactor port includes a fuel feed hopper. The fuel loading apparatus may also include where the fuel inlet port and the reactor port extend from the transfer tube wall in opposite directions. The fuel loading apparatus may also include where the vacuum port is located between the fuel inlet port and the reactor port. The fuel loading apparatus may also include where the fuel carriage further includes a piston extending a first end of the carriage to a piston free end configured to rotate the fuel carriage. The fuel loading apparatus may also include a cam barrel mechanism configured to translate the fuel carriage along and/or about a longitudinal axis of the transfer tube. The fuel loading apparatus may also include at least one actuator configured to translate the fuel carriage along and/or rotate the fuel carriage about a longitudinal axis of the transfer tube. The fuel loading apparatus may also include where the fuel carriage is configured to receive a plurality of fuel particles having particle sizes greater than one centimeter. The fuel loading apparatus may also include where the transfer tube further includes a transfer tube dead end configured to at least partially receive the fuel carriage. The fuel loading apparatus may also include where the first sealing member and the second sealing member are spaced apart at a distance further than the vacuum port and/or carriage aperture. The fuel loading apparatus may also include where the fuel carriage has at least one freedom of movement relative to a transfer tube or a portion thereof. The fuel loading apparatus may also include where the fuel carriage includes a port extending from the inner cavity through the outer carriage surface, where the port is configured to couple with a vacuum port coupling so as to evacuate a fluid within the inner cavity. The fuel loading apparatus may also include where the pressure in the reactor vessel is greater than or less than ambient pressure. The fuel loading apparatus may also include where the fuel carriage includes a channel extending between the first sealing member and a second sealing member or between the third sealing member and a fourth sealing member, where the channel extends through the outer carriage surface of the fuel carriage, where the channel is configured to equilibrate to the pressure within the reactor or the pressure of the fuel inlet depending on a location of the fuel carriage within the transfer tube. The fuel loading apparatus may also include where the fuel carriage includes a channel extending between the first sealing member and a second sealing member and/or between the third sealing member and a fourth sealing member, where the channel has a pressure which is greater than, less than, or between a reactor pressure and an inlet pressure, where the pressure in the channel is configured to equilibrate to either the reactor pressure or the inlet pressure upon at least partial failure of at least one of the first seal, the second seal, the third seal, and the fourth seal. Other technical features may be readily apparent to one skilled in the art from the following figures, descriptions, and claims.

In another aspect, a method for continuously loading fuel into an aluminum-water reactor system, the method includes placing a fuel carriage into a fuel loading position within a transfer tube, passing a plurality of fuel particles through a fuel inlet of the transfer tube and thereby through a carriage aperture and into an inner carriage cavity of the fuel carriage, evacuating air from the carriage cavity through a vacuum port, sliding the fuel carriage along the longitudinal axis of the transfer tube and/or rotating the fuel carriage about the longitudinal axis of the transfer tube into a transfer position by moving the fuel carriage towards an aperture in alignment with a reactor port of the transfer tube, and exiting the plurality of fuel particles from the fuel carriage through the reactor port. In some embodiments, the method may also include rotating the fuel carriage along the longitudinal axis of the transfer tube and/or rotating the fuel carriage about the longitudinal axis of the transfer tube into a reactor loading position such that the carriage aperture faces a reactor port. The method may also include sealing the inner carriage cavity from the fuel inlet and/or the reactor port prior to the evacuating air from the carriage cavity step. The method may also includes moving the fuel carriage along the longitudinal axis of the transfer tube and/or rotating the fuel carriage about the longitudinal axis of the transfer tube with a cam barrel mechanism. The method may also includes moving the fuel carriage along the longitudinal axis of the transfer tube and/or rotating the fuel carriage about the longitudinal axis of the transfer tube with at least one linear actuator. The method may also include where the vacuum port is located between the fuel inlet port and the reactor port. The method may also includes maintaining at least one seal between the reactor vessel and an outside environment. The method may also include where the fuel carriage includes a port extending from the inner cavity through the outer surface, where the port is configured to couple with a vacuum port coupling so as to evacuate a fluid within the inner cavity. The method may also include where the fuel carriage includes a channel extending between the first sealing member and a second sealing member and through the exterior surface for the fuel carriage, where the channel is configured to equilibrate to the pressure within the reactor or the pressure of the fuel inlet depending on a location of the fuel carriage within the transfer tube. The method may also include where the fuel carriage includes a channel extending between the first sealing member and a second sealing member, or between the third sealing member and a fourth sealing member, where the channel extends through the exterior surface for the fuel carriage, where the channel is configured to equilibrate to the pressure within the reactor or the pressure of the fuel inlet depending on a location of the fuel carriage within the transfer tube. The method may also include where the piston and the carriage body are coaxially aligned along a longitudinal axis of the fuel carriage. Other technical features may be readily apparent to one skilled in the art from the following figures, descriptions, and claims.

In some embodiments, the fuel loading apparatus may also include where the first sealing member and the third sealing member are configured to form the first seal and the third seal on a first side of the first carriage aperture and the second sealing member and the fourth sealing member are configured to form the second seal and the fourth seal on a second side of the first carriage aperture which is opposite to the first side relative to the carriage aperture thereby forming a double sealed airlock. The fuel loading apparatus may also include where at least one of first, second, third, and fourth sealing members is configured to form and maintain a seal between a reactor vessel and an outside environment. The fuel loading apparatus may also include where the piston and the carriage body are coaxially aligned along a longitudinal axis of the fuel carriage. The fuel loading apparatus may also include where the piston is coupled with an actuator and a guide rail so as to move the piston between a first position and a second position along a longitudinal axis of the fuel loading apparatus. The fuel loading apparatus may also include where the guide rail is threaded. The fuel loading apparatus may also include where the transfer tube dead end aligns the fuel carriage along a longitudinal axis of the transfer tube and/or rotate about the longitudinal axis of the fuel carriage with the reactor port such that the carriage aperture is aligned with the reactor port cavity. The fuel loading apparatus may also include where the freedom of movement is axial translation within the transfer tube or relative to the ports thereof, rotational movement relative to the transfer tube or relative to the ports thereof, or a combination of axial translation and rotational movement relative to the transfer tube or relative to the ports thereof. The fuel loading apparatus may also include where the port extends along a longitudinal axis of the fuel carriage. The fuel loading apparatus may also include where the channel coupled with one or more sensors configured to detect the pressure within the channel and, optionally the location of the fuel carriage within the transfer tube. A system including a processor and the fuel loading apparatus may also include where the one or more sensors configured to relay the detected pressure within the channel and/or and location of the fuel carriage within the transfer tube to the processor, the processor is configured to compare the detected pressure within the channel and the location of the fuel carriage within the transfer tube to a desired pressure associated with a correlated location of the fuel carriage within the transfer tube, and the processor is configured to relay a signal to indicate failure if the detected pressure determined by the sensor at the location is above or below a predetermined desired threshold pressure associated with that correlated location to indicate a reduction in effectiveness of the first seal and/or the second seal. The may also include where the indication of a reduction in effectiveness of the first seal and/or the second seal is an audio signal, a visual signal, a mechanical cue, an electrical signal to a second processor, or a combination of two or more thereof. The system may also include where in response to the indication of failure, closing a valve so as to stop fuel loading. The method may also include where the channel is configured to couple with one or more sensors, where the one or more sensors are configured to detect the pressure within the channel and the location of the fuel carriage within the transfer tube. The method may also include detecting the pressure within the channel and/or and location of the fuel carriage within the transfer tube assembly with a sensor, transmitting the signal from the sensor to a processor, comparing the detected pressure within the channel and the location of the fuel carriage within the transfer tube assembly with a desired pressure correlated with the location of the fuel carriage within the transfer tube with the processor, transmitting a signal from the processor to indicate failure if the detected pressure determined by the sensor at the location is above or below a predetermined desired threshold pressure associated with that correlated location indicating a reduction in effectiveness of the first seal, the second seal, the third seal, and/or the fourth seal. The method may also include where the pressure in the reactor vessel is greater than or less than ambient pressure. The method may also include where indicating a reduction in effectiveness of the first seal, the second seal, the third seal, and/or the fourth seal includes transmitting an audio signal, a visual signal, a mechanical cue, an electrical signal to a second processor, or a combination of two or more thereof. The method may also include where in response to an indication of failure, closing a valve so as to stop fuel loading. The method may also include where piston is coupled with an actuator and a guide rail so as to move the piston between a first position and a second position along a longitudinal axis of the fuel loading apparatus. Other technical features may be readily apparent to one skilled in the art from the following figures, descriptions, and claims.

### DEFINITIONS

As used herein the term “top view” refers to a view from the perspective where the viewing angle is directly inline with the z axis, allowing the x and y dimensions to be seen without distortion.

As used herein the term “bottom view” refers to a view from the perspective where the viewing angle is directly inline with the z axis, but from the opposite direction of the top down view defined above.

As used herein the term “side view” refers to view from the perspective where the viewing angle is directly inline with the x axis, allowing the y and z dimensions to be seen without distortion.

As used herein the terms “front view” and “back view” refer to views from the perspective where the viewing angle is directly inline with the y axis, allowing the x and z dimension to be seen without distortion

As used herein the term “isometric view” refers to a view from the perspective where the viewing angle is at an angle from each of the x, y, and z axes.

As used herein the term “exploded view” refers to a view from the perspective where the components have been artificially spaced out from one another as to allow for clear viewing of internal and overlapping components.

As used herein the term “planar cutaway view” refers to a cross-sectional view along a plane passing through at least a portion of a system or device where the portions of the system or device before the viewing plane are not shown.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, physical, mechanical, or other manner.

As used herein, the term “about” means within ±10% of the value it modifies. For example, “about 1” means “0.9 to 1.1”, “about 2%” means “1.8% to 2.2%”, “about 2% to 3%” means “1.8% to 3.3%”, and “about 3% to about 4%” means “2.7% to 4.4%.” Unless otherwise clear from the context, all numerical values provided herein are modified by the term “about.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” As used herein the term “particle diameter,” “fuel diameter,” or “particle size” refers to a particle characterized by an equivalent spherical sieve diameter.

As used herein, the term “filter” refers to any mesh, screen, non-woven fibrous material, or any other material used to separate particles by size or chemical group.

As used herein, the term “exfoliate” refers to reduction in particle size due to the continuous removal of one or more surface layers and/or disintegration of the particle along grain boundaries thereby exposing additional and/or different surface areas of the particle that are without oxide coverage to the fuel. For example, when an aluminum fuel particle is exfoliated at least a portion of a surface layer is removed from the aluminum fuel surface to expose a fresh surface of the fuel with no oxide coverage. Further, successive layers of the surface of the aluminum particle may be removed from the aluminum particle through exfoliation. Also, the aluminum particle may disintegrate along grain boundaries through exfoliation.

As used herein the term “tray,” “tray of pellets,” or “trays of pellets” is used interchangeably with pucks, briquettes, and large particles. For example, large particles as described herein may include particles having at least one dimension exceeding five millimeters. For example, the larger particles of aluminum-based fuel fed into reactors as described herein are larger than the feed fuel used in traditional aluminum-water reactors.

### BRIEF DESCRIPTION OF THE DRAWINGS

Figures illustrated herein are exemplary block drawings showing relative positions of certain elements described herein. However, the figures do not show the exact couplings or connections that may or may not exist between elements. Additionally, in some drawings, internal and external features may be shown in the same renderings for conceptualizing the overall concepts and not for conceptualizing them from an engineering perspective.

FIG. 1 illustrates a continuous aluminum-water reactor system and configuration of a reaction vessel, according to embodiments described herein.

FIG. 2A illustrates a fuel loading apparatus configured in a fuel loading position, according to embodiments described herein.

FIG. 2B illustrates the fuel loading apparatus of FIG. 2A in an air evacuation position, according to embodiments described herein.

FIG. 2C illustrates the fuel loading apparatus of FIG. 2A in a transfer position, according to embodiments described herein.

FIG. 2D illustrates the fuel loading apparatus of FIG. 2A in a reactor loading position, according to embodiments described herein.

FIG. 3 illustrates a fuel loading apparatus having a fuel carriage coupled with a vacuum port configured to evacuate air from the fuel carriage in a direction parallel with the axis of motion of the fuel carriage, according to embodiments described herein.

FIG. 4 illustrates a side view of a fuel loading apparatus, according to embodiments described herein.

FIG. 5A illustrates a top down view of a fuel carriage, according to embodiments described herein.

FIG. 5B illustrates an isometric view of the fuel carriage shown in FIG. 5A, according to embodiments described herein.

FIG. 5C illustrates a front view of the fuel carriage shown in FIG. 5A, according to embodiments described herein.

FIG. 5D illustrates a back view of the fuel carriage shown in FIG. 5A, according to embodiments described herein.

FIG. 6 illustrates a cross section of an exemplary fuel carriage having a channel disposed between a first seal and a second seal, according to embodiments described herein.

FIG. 7A illustrates a bottom view of a transfer tube, according to embodiments described herein.

FIG. 7B illustrates a top view of the transfer tube shown in FIG. 7A, according to embodiments described herein.

FIG. 7C illustrates a side view of the transfer tube shown in FIG. 7A, according to embodiments described herein.

FIG. 7D illustrates an isometric view of the transfer tube shown in FIG. 7A from a top perspective, according to embodiments described herein.

FIG. 7E illustrates an isometric view of the transfer tube shown in FIG. 7A from a bottom perspective, according to embodiments described herein.

FIG. 7F illustrates a front view of the transfer tube shown in FIG. 7A, according to embodiments described herein.

FIG. 7G illustrates a back view of the transfer tube shown in FIG. 7A, according to embodiments described herein.

FIG. 8A illustrates a side view of the assembled fuel loading apparatus, according to embodiments described herein.

FIG. 8B illustrates a top view of the assembled fuel loading apparatus of FIG. 8A, according to embodiments described herein.

FIG. 8C illustrates an isometric view of the assembled fuel loading apparatus of FIG. 8A, according to embodiments described herein.

FIG. 8D illustrates a planar cross-sectional view of the assembled fuel loading apparatus of FIG. 8A from a perspective of a plane passing through a longitudinal axis of the fuel carriage, according to embodiments described herein. In this view, the internal components of the fuel loading apparatus are visible in their assembled positions, along with the internal channels and cavities of the fuel loading apparatus.

FIG. 8E illustrates a side view of the assembled fuel loading apparatus of FIG. 8A, illustrating internal components of the non-stationary piston assembly, according to embodiments described herein.

FIG. 8F illustrates a front view of the fuel loading apparatus, according to embodiments described herein.

FIG. 8G illustrates a back view of the fuel loading apparatus, according to embodiments described herein.

FIG. 9A illustrates a top view of a piston assembly, according to embodiments described herein.

FIG. 9B illustrates an aspect of the subject matter in accordance with one embodiment.

FIG. 10 illustrates an aspect of the subject matter in accordance with one embodiment.

FIG. 11 illustrates an exemplary diagram of a piston assembly coupled with a vacuum reservoir according to embodiments described herein.

FIG. 12 illustrates an example of a method for continuously loading fuel into an aluminum-water reactor system, according to embodiments described herein.

### DETAILED DESCRIPTION

The reaction between aluminum and water is a highly exothermic process resulting in hydrogen gas and heat which can be used to produce energy. Provided herein are systems, methods, and devices for reacting water with aluminum and removing a protective oxidative layer through chemical or mechanical means. Systems, methods, and devices of the present disclosure create a high throughput process for an efficient and controlled reaction.

Current approaches to aluminum-water reactor system includes using a batch process and associated system to react water with aluminum. Water is added to the reaction in pulses or through a single large addition. The reaction byproducts and any water that has not reacted with the aluminum or vaporized is collected in a reactor vessel. Once the fuel is consumed, the reactor vessel or container is shut down and emptied to add more reactants. Shutting down the reactor may be costly and time consuming.

Further, the reactor vessel size needed to support megawatt (MW) or gigawatt (GW) scale energy production in a batch process is expensive and includes safety concerns due to the large volume/mass of fuel needed to operate for more than a few hours. Also, in a batch process, as byproduct accumulates and fuel is consumed, the concentration of active fuel relative to byproduct decreases over time eventually resulting in a ‘cooldown’ period where the power output required is no longer sufficient and the remaining fuel is wasted or discarded.

Provided herein are systems, methods, and devices to support industrial processes and large-scale energy and hydrogen demands while operating safely, continuous aluminum-water reaction systems with continuous additions of fuel are needed to continuously operate the aluminum-water reaction alongside existing infrastructure.

These continuous processes and systems that provide a safe, controlled, and efficient reaction between aluminum and water. These improved continuous processes, devices, and systems support continuous addition of fuel, remove the oxide layer, precise addition of water, predictable initiation and completion of the reaction, run continuously, safety, and cost efficiency.

Certain aspects of embodiments disclosed herein are directed to systems, methods, and devices including continuous tube reactors and continuous aluminum-water reactor systems for the continuous addition of fuel to an aluminum-water reactor. In some embodiments, continuous aluminum-water reactor systems support continuous fuel addition, continuous removal of byproduct, and continuous power output.

The reactor vessels or plurality of reactor vessels described herein support the addition of aluminum fuel having relatively larger (e.g., greater than 1 centimeter in at least one dimension) particle size or ranges of sizes. Some embodiments of the continuous aluminum-water reactor system are directed towards reducing the need to pre-shred or pulverize the active fuel to increase surface area which takes considerable energy. High surface area in fuel is important for aluminum-water reactions because as the available surface area for aluminum and water to react increases, the rate of the reaction and therefore maximum power output also increases.

Systems, methods, and devices of the present disclosure feed large solids such as aluminum briquettes continuously to reactors operating at high temperature and pressure.

Systems, methods, and devices of the present disclosure exfoliate larger aluminum fuel particles, such as aluminum briquettes, within the reactor to increase surface area for the reaction to occur.

Due to the unique configuration of systems described herein, larger particles of fuel are broken down or exfoliated within the reactor, reducing additional energy needed to break down the fuel. Larger particle sizes of aluminum fuel may also be safer to store and handle because they are relatively inert with relatively low surface area until they enter the reactor and are broken down. The continuous aluminum-water reactor system also provides systems and methods to convert reactive byproducts produced by the vessel reactor into relatively inert byproducts such as aluminum oxyhydroxide, thereby reducing safety risks.

The continuous aluminum-water reactor processes and systems described herein are configured to exfoliate aluminum fuel to remove the protective oxidative layer in controlled conditions with no oxygen or negligible amounts of oxygen. Removal of oxygen from the reactor vessels performing aluminum-water reactions may reduce safety risks such as explosive hazards and catalyst breakdown.

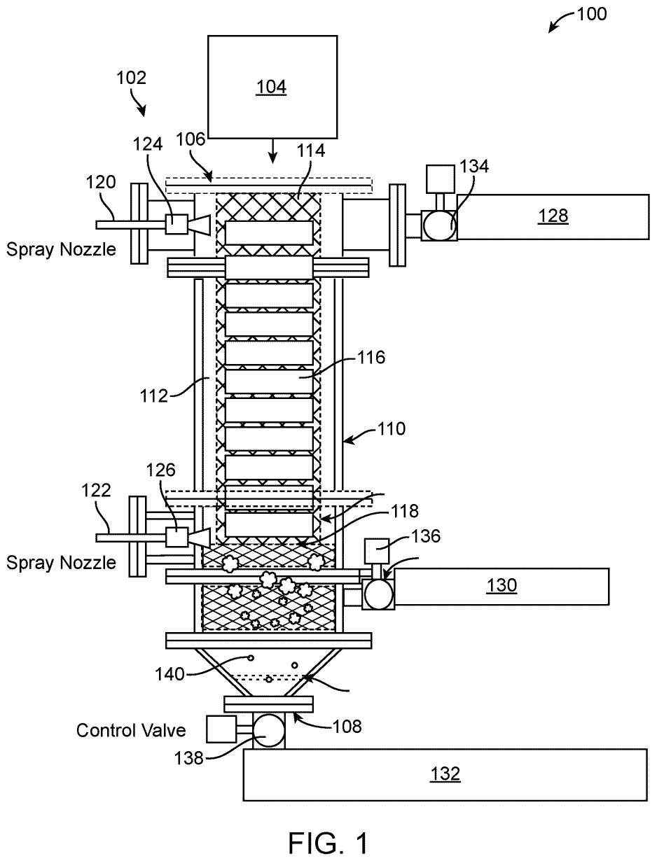

FIG. 1 illustrates an embodiment of a continuous aluminum-water reactor system 100 having a reactor vessel 102, fuel loading apparatus 104, and a plurality of inlet and outlet streams. In some embodiments, the reactor vessel 102 has a first vessel end 106, a second vessel end 108, and a vessel wall 110 therebetween. In some embodiments, the reactor vessel 102 is hollow and has a longitudinal interior cavity 112 extending from the first vessel end 106 to the second vessel end 108.

In some embodiments, at least a portion of the reactor vessel 102 has a generally truncated conical shape. In some embodiments, the reactor vessel 102 has a generally cylindrical shape. In some embodiments, the reactor vessel 102 is a tube reactor. In some embodiments, the reactor vessel 102 is a standard flanged pipe. In some embodiments, the reactor vessel 102 has a shape configured to facilitate the reaction of water with aluminum.

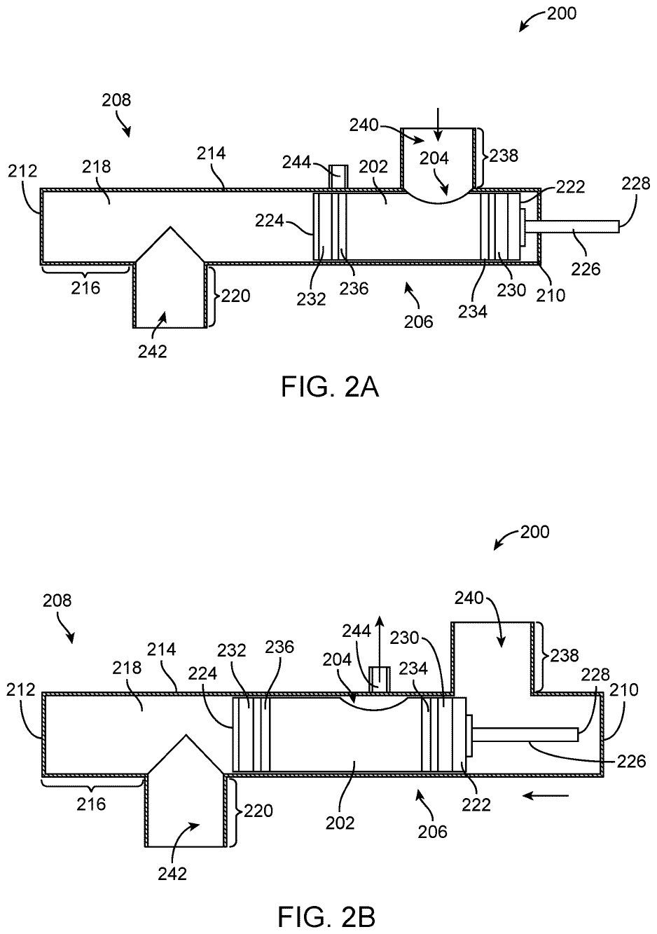

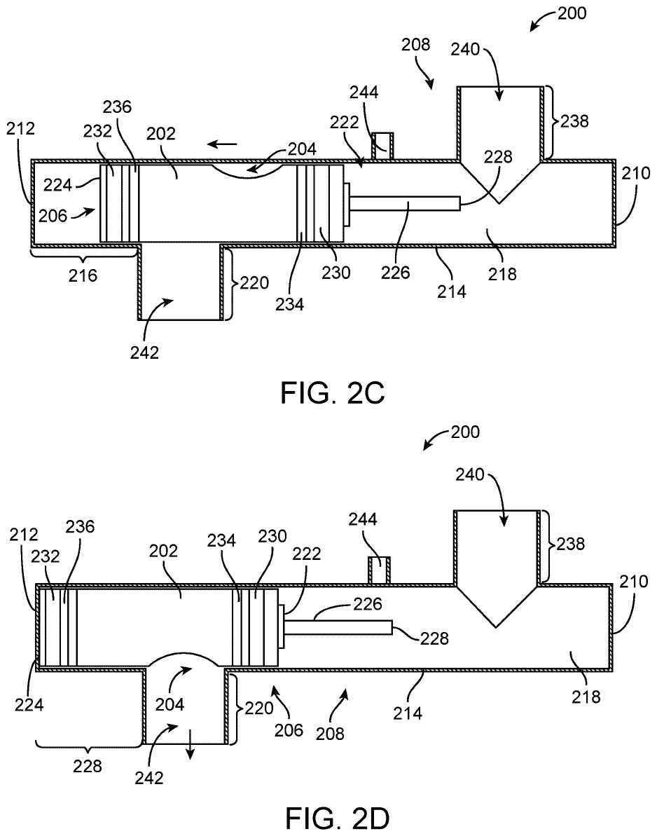

In some embodiments, the reactor vessel 102 is configured to operate at a pressure greater than 100 psi and a temperature greater than 114 °C. In some embodiments, fuel is added from the fuel loading apparatus 104 to the reactor vessel 102 at the first vessel end 106. In some embodiments, the reactor vessel 102 is configured to include a fuel port (see FIGS. 2A-2D) for continuously adding fuel into the reactor vessel 102. In some embodiments, a plurality of fuel particles is added to the reactor vessel 102 without oxidizing or reducing pressure within the interior cavity 112 of the reactor vessel 102.

In some embodiments, the fuel comprises aluminum. In some embodiments, the fuel comprises activated aluminum fuel. In some embodiments, the fuel is added to the reactor vessel 102 continuously. In some embodiments, fuel is added to the reactor vessel 102 without shutting down the reactor vessel 102 to add the fuel. In some embodiments, fuel is added to the reactor vessel 102 as larger particles. In some embodiments, the reactor vessel 102 is configured to exfoliate particles of fuel to reduce the size of the particles of fuel within the interior cavity 112 of the reactor vessel 102. In some embodiments, the plurality of fuel particles initially added into the reactor vessel 102 are larger than one inch in at least one dimension. In some embodiments, the size of fuel particles entering the continuous aluminum-water reactor system 100 have a widest dimension smaller than the carriage body 202 and/or carriage aperture 204. In some embodiments, the plurality of fuel particles added initially into the reactor vessel 102 have at least one dimension exceeding 5 millimeters. In some embodiments, the plurality of fuel particles added initially into the reactor vessel 102 are larger than one centimeter in at least one dimension. In some embodiments, at least a portion of the particles of fuel leaving the reactor have at least one dimension in the micrometer or nanometer size range. In some embodiments, one or more byproducts comprises a plurality of exfoliated fuel particles having at least one dimension less than 1000 micrometers.

In some embodiments, the filter 114 of the reactor vessel 102 has one or more trays 116 configured to hold pellets of fuel and located between the first vessel end 106 and the filter bottom surface 118. In some embodiments, fuel is added to the reactor vessel 102 as large particles (having at least one dimension exceeding one centimeter), aluminum pucks, trays of pellets, briquettes, or any combination thereof.

In some embodiments, a portion of the plurality of fuel particles initially added to the reactor vessel from the fuel loading apparatus 104 are retained on a filter 114, platform, or bed within the reactor vessel configured to prevent the fuel from falling to the bottom of the reactor vessel. In some embodiments, the particles of fuel initially added to the reactor vessel from the fuel loading apparatus 104 are retained within the interior cavity 112 by a filter bottom surface 118 of a filter 114. In some embodiments, the filter bottom surface 118 comprises a screen disposed at least partially transverse to the longitudinal axis of the reactor vessel. In some embodiments, the filter bottom surface 118 is configured to hold a first plurality of particles having a particle size larger than a size of mesh opening for the filter bottom surface 118 size.

In some embodiments, particles larger than opening size in the filter 114 remain within the filter 114 forming a fuel bed. In some embodiments, particles larger than opening size in the filter 114 remain between first vessel end 106 and the filter 114 forming a fuel bed. In some embodiments, a plurality of fuel particles located in the fuel bed between first vessel end 106 and the filter 114 is exfoliated until the particle size of the fuel is smaller than the opening size of the filter 114 mesh permitting the plurality of fuel particles to pass through the filter 114. In some embodiments, a portion of the plurality of fuel particles initially added to the reactor is exfoliated until the particle size permits the exfoliated fuel to pass through the filter 114 to support further wetting and exfoliation of the portion of fuel particles within the reactor vessel. In some embodiments, the plurality of fuel particles comprises aluminum. In some embodiments, at least one reaction byproduct is aluminum oxyhydroxide.

In some embodiments, the reactor vessel 102 has at least one inlet pipe. In some embodiments, the reactor vessel 102 has a first inlet pipe 120 and a second inlet pipe 122. In some embodiments, at least one inlet pipe 120, 122 is configured to provide water to the interior cavity 112 of the reactor vessel 102. In some embodiments, at least one inlet pipe is coupled with a spray nozzle. In some embodiments, the first inlet pipe 120 is coupled to a first spray nozzle 124. In some embodiments, the second inlet pipe 122 is coupled to a second spray nozzle 126. In some embodiments, the first and second inlet pipes 120, 122 are configured to provide water to the reactor vessel 102. In some embodiments, the first and second inlet pipes 120, 122 are configured to provide water and at least one additive to the reactor vessel. In some embodiments, the additive comprises sodium chloride, sodium hydroxide, sodium sulfate, chelating compounds, caffeine, or any combination thereof. In some embodiments, the additive is a chelating compound.

In some embodiments, the at least one spray nozzle is configured to exfoliate large particles of aluminum-based fuel or large fuel briquettes retained in a tray 116 by spraying water directly on the fuel. In some embodiments, at least one spray nozzle is configured to spray water to feed the high-power reaction occurring from partially exfoliated fuel particles below the filter 114.

In some embodiments, the reactor vessel has at least one outlet stream exiting the reactor vessel. In some embodiments, the reactor vessel has a first outlet stream 128, and a second outlet stream 130, and a third outlet 132. In some embodiments, the first outlet stream 128 is coupled to a first control valve 134, the second outlet stream 130 is coupled to a second control valve 136, and the third outlet 132 is coupled to a third control valve 138.

In some embodiments, the first control valve 134, the second control valve 136, the third control valve 138, or any combination thereof is an automated or manual control valve. In some embodiments, the first control valve 134 is configured to regulate the pressure or flow rate from the reactor vessel such as to support downstream separation and to meet the desired output. In some embodiments, third control valve 138 is configured to regulate the pressure or flow rate for liquids and solids from the reactor vessel to support downstream separation and to meet the desired output.

FIG. 2A illustrates an embodiment of a fuel loading apparatus 200 having a fuel carriage 206 and a transfer tube 208 in a fuel loading position. In some embodiments, the transfer tube 208 has a transfer tube first end 210, a transfer tube second end 212, and a transfer tube wall 214 therebetween. In some embodiments, the transfer tube wall 214 has a generally cylindrical shape. In some embodiments, the transfer tube wall 214 and the transfer tube second end 212 form a transfer tube dead end 216 where the transfer tube wall 214 encircles a solid transfer tube second end 212. In some embodiments, the transfer tube dead end 216 is a closed or otherwise terminating end or terminus that prevents translation of the fuel carriage beyond a fixed location within the translation tube. In some embodiments, a transfer tube passageway 218 is disposed at least partially through a longitudinal axis of the transfer tube 208. In some embodiments, the transfer tube dead end 212 aligns the fuel carriage along the longitudinal axis of the transfer tube and/or about the longitudinal axis of the transfer tube with the reactor port such that a carriage aperture 204 is aligned with the reactor port 220 cavity.

In some embodiments, the fuel carriage 206 is configured to be disposed within the transfer tube passageway 218. In some embodiments, the fuel carriage 206 comprises a carriage body 202 extending from a carriage first end 222 to a carriage second end 224. In some embodiments, the carriage body 202 is generally cylindrically shaped. In some embodiments, a piston 226 extends from the carriage first end 222 to a piston free end 228. In some embodiments, the piston 226 is configured to have a smaller diameter than the carriage body 202. In some embodiments, the carriage body 202 and the piston 226 are configured to be coaxial with the longitudinal axis of the fuel carriage 206.

In some embodiments, the fuel carriage 206 comprises at least one sealing member configured to form a seal between an outer surface of the carriage body 202 and an inner surface of the transfer tube passageway 218. In some embodiments, the fuel carriage 206 comprises a first sealing member 230 disposed around the outer surface of the carriage body 202. In some embodiments, the fuel carriage 206 comprises a first sealing member 230 and a second sealing member 232 each disposed around the outer surface of the carriage body 202. In some embodiments, the first sealing member 230 is located adjacent to the carriage first end 222 and the second sealing member 232 is located adjacent to the carriage second end 224.

In some embodiments, the fuel carriage 206 comprises a first sealing member 230, a second sealing member 232, a third sealing member 234, and a fourth sealing member 236 each disposed around the outer surface of the carriage body 202. In some embodiments, all sealing members are elastomeric sealing members. For example, all sealing members may be round O-rings, X-rings, Quadrings, configured with back up rings, or any other profile generally known for accomplishing static or dynamic diametrical sealing. In some embodiments, the sealing members are configured to be all the same type, all different types, or any combination thereof. In some embodiments, there are two sets of sealing members, or one set of sealing members, or any number of set of sealing members located at or adjacent to each end of piston 226. In some embodiments, the first sealing member 230 and the third sealing member 234 are located adjacent to the carriage first end 222 where the first sealing member 230 is located between the third sealing member 234 and the carriage first end 222. In some embodiments, the second sealing member 232 and the fourth sealing member 236 are located adjacent to the carriage second end 224, where the second sealing member 232 is located between the fourth sealing member 236 and the carriage second end 224. In some embodiments, each of the first sealing member 230, the second sealing member 232, the third sealing member 234, and the fourth sealing member 236 are configured to form a seal and/or airlock between the outer surface of the carriage body 202 and the inner surface of the transfer tube passageway 218.

In some embodiments, a fuel inlet port 238 extends radially from the transfer tube wall 214 and includes a fuel inlet port cavity 240 extending through the fuel inlet port 238 and the transfer tube wall 214 into the transfer tube passageway 218. In some embodiments, the fuel inlet port 238 is configured as a passageway to load fuel into the transfer tube passageway 218 and/or fuel carriage 206. In some embodiments, the fuel inlet port cavity 240 comprises a fuel feed hopper. In some embodiments, the fuel carriage 206 is configured to receive a plurality of fuel particles having particle sizes greater than one centimeter. In some embodiments, the fuel comprises solid aluminum particles. In some embodiments, the fuel inlet port cavity 240 and the reactor port cavity 242 are offset from each other relative to the transfer tube 208. For example, the fuel inlet port cavity 240 may extend in a first direction away from the transfer tube wall 214 and the reactor port 220 may extend in a second direction opposite the first direction away from the transfer tube wall 214. In some embodiments, the fuel inlet port cavity 240 and the reactor port 220 are offset axially, longitudinally, or both axially and longitudinally relative to each other.

In some embodiments, the fuel inlet port 238 is positioned between at least one of the first sealing member 230 and the third sealing member 234 and at least one of the second sealing member 232 and the fourth sealing member 236 when the fuel carriage 206 is in a fuel loading position. In some embodiments, at least one sealing member is configured to form and maintain a seal between the reactor and the outside environment.

In some embodiments, a reactor port 220 extends radially from the transfer tube wall 214 and includes a reactor port cavity 242 extending from the inner cavity of a reactor through the reactor port 220 and the transfer tube wall 214 into the transfer tube passageway 218.

In some embodiments, the fuel carriage 206 has an opening or hollow portion within the outer surface of the carriage body 202 forming a carriage cavity (not shown). In some embodiments, the fuel carriage 206 comprises a carriage aperture 204 disposed through at least a portion of the outer surface of the carriage body 202 and into the carriage cavity. In some embodiments, the carriage aperture 204 is positioned to face the fuel inlet port cavity 240 when the fuel carriage 206 is in a fuel loading position. In some embodiments, fuel is loaded into the carriage cavity by passing through the fuel inlet port cavity 240 and carriage aperture 204.

In some embodiments, the fuel carriage 202 has a second carriage aperture (not shown) configured to provide alignment with a vacuum port and an aperture for loading and releasing a plurality of fuel particles. In such embodiments, the axial rotations and/or longitudinal movements are adapted to ensure that the sequence of loading, vacuum air removal, and unloading are maintained with the proper seals therebetween. In some embodiments, the fuel carriage 202 has a second and a third carriage aperture for alignment with the vacuum port and a fuel inlet port, respectively, as well as the carriage aperture for the release of the plurality of fuel particles through the reactor port. In some embodiments, the third and second apertures are configured to be offset relative to each other axially or to be spaced a different distance apart longitudinally from each other relative to the fuel port and the vacuum port so as to not simultaneously align with the vacuum port and the fuel port. In some embodiments, the aperture is positioned on a distal end of the fuel carriage 202 and the reactor port is on a distal end of the transfer tube 208, while the vacuum aperture and/or a fuel aperture is on the proximal end of the fuel carriage 202 along with a rotation handle that may be coupled to an actuator for rotation of the fuel carriage 202 within the transfer tube to expose the reactor aperture to the reactor port after vacuum is pulled. In some embodiments, the fuel inlet port and the vacuum port are aligned with the fuel aperture and the vacuum aperture, and at least one seal exists therebetween. The fuel aperture may be sealable to the carriage inner carriage cavity when the vacuum is pulled through said vacuum aperture and thereafter. In some embodiments, the vacuum port is not aligned with the vacuum aperture when the fuel aperture is aligned with the fuel inlet port. Alternatively, a single fuel/vacuum aperture is in the fuel carriage 202, and such fuel/vacuum aperture is movable in fluid communication with the fuel inlet port for fuel loading and then movable in fluid communication with the vacuum aperture for vacuum of the air or oxygen or other gas from the fuel carriage 202. During both of these loading and vacuuming steps, the reactor aperture is not aligned with the reactor port. Alternatively, such a reactor port is aligned with the reactor aperture but is otherwise sealed or blocked from allowing the fuel to exit such aperture and/or port.

In some embodiments, a spray nozzle or plurality of spray nozzles is disposed into the piston bore. In some embodiments, the spray nozzle or the plurality of spray nozzles is fed by a water source that also feeds the reactor vessel 102 (see FIG. 1). In some embodiments, a valve is configured to actuate the spray nozzle. In some embodiments, a plurality of valves is configured to actuate a plurality of spray nozzles, wherein the plurality of valves comprise all the same type of valve or a combination of several different types of valves. In some embodiments, the valve is a solenoid valve, ball valve, or any other valve capable of controlling fluid flow. In some embodiments, at least one valve is configured to be controlled electronically. In some embodiments, one or more valves are actuated to open or close at each cycle of the piston 226. In some embodiments, the valves are configured to be actuated to open or close in response to any state of the continuous aluminum-water reactor system 100 including vacuum pressure, temperature, throughput, or any other measurable state. In some embodiments, the valves are configured to actuated to an open or closed position within combination with the movement of the piston 226 so as to maintain a contamination free piston bore and sealing surface.

In some embodiments, the fuel loading apparatus 200 includes wipers seals and/or cleaning brushes (not shown). In some embodiments, water delivered by the spray nozzles is routed to a subsystem of the continuous aluminum-water reactor system 100, including the reactor vessel 102 or a separate discharge reservoir. In some embodiments, the spray nozzles are configured to deliver water or any other fluid including gas.

FIG. 2B illustrates the fuel loading apparatus 200 of FIG. 2A in an air evacuation position, according to an embodiment herein.

In some embodiments, one or more sealing members 232, 236, 234, and 230 are configured to form an airlock between outer surface of the carriage body 202 and the inner surface of the transfer tube passageway 218 to evacuate air. For example, when the fuel loading apparatus 200 is in an air evacuation position the vacuum port 244 may be disposed between the third sealing member 234 and the fourth sealing member 236. When in the air evacuation position, for example, the carriage aperture 204 may be configured to face the vacuum port 244. The vacuum port 244 may be attached to a pump or other device configured to pull a vacuum on the inner cavity of the fuel carriage 206 to evacuate a small amount of air within the carriage cavity. As shown in FIG. 2B, for nonlimiting example, the vacuum port 244 is shown with a direction of air evacuated, for example, atmospheric air, is shown with a black arrow. In this example, vacuum is pulled with a vacuum pump connected thereto (not shown). In some embodiments, the vacuum port 244 is configured to evacuate air from the carriage cavity after the carriage cavity is filled with fuel and before the fuel is deposited into the reactor vessel. In some embodiments, the vacuum port 244 is configured to provide minimal changes in pressure and volume to the reactor vessel while fuel is added to the reactor vessel from the fuel inlet port 238.

In some embodiments, the first sealing member 230 and the third sealing member 234 are configured to form a first seal and a third seal on a first side of the carriage aperture 204 and the second sealing member 232 and the fourth sealing member 236 are configured to form the second seal and the fourth seal on an opposite side of the carriage aperture thereby forming a double sealed airlock. In some embodiments, the vacuum port is located between the fuel inlet port 238 and the reactor port 220.

In some embodiments, the vacuum port 244 is configured to prevent and/or minimize oxygen entering the reactor vessel 102. In some embodiments, the continuous aluminum-water reactor system 100 is designed to support the recovery of a eutectic catalyst by maintaining certain reaction conditions and limiting reactor exposure to oxidation from air.

FIG. 2C illustrates the fuel loading apparatus 200 of FIG. 2A in a transfer position, according to an embodiment herein. In some embodiments, when the fuel loading apparatus 200 is in a transfer position, the carriage second end 224 moves towards the transfer tube second end 212. In some embodiments, the transfer tube dead end 216 is configured to at least partially receive the carriage body 202. In some embodiments, the transfer tube dead end 216 is configured to prevent the carriage body 202 from moving past the transfer tube second end 212. In some embodiments, the transfer tube dead end 212 aligns the fuel carriage 202 or a portion thereof along a longitudinal axis of the fuel carriage and/or rotate about a longitudinal axis of the fuel carriage with the reactor port 220 such that the carriage aperture 204 is aligned with the reactor port cavity 242. In some embodiments, the reactor port 220 and transfer tube dead end 216 are positioned in proximity so that when the carriage second end 224 abuts the transfer tube second end 212 of the transfer tube dead end 216 the carriage aperture 204 is positioned in line with the reactor port cavity 242 of the reactor port 220.

In some embodiments, a first linear actuator (not shown) controls the movement of the piston 226 extending from the fuel carriage 206 through the transfer tube passageway 218 of the transfer tube 208. As shown, for example in FIG. 2B, the linear or longitudinal translation or movement of the piston 226 connected to the fuel carriage 202 translates or moves the fuel carriage 202 longitudinally relative to the transfer tube and/or the ports (vacuum port 244, fuel inlet port 238, reactor port 220), for example in a sequential movement as shown by the arrow below the piston 226 from a fuel loading position where the carriage aperture 204 is open to the fuel inlet port 238 and a plurality of fuel particles may be loaded into the inner carriage cavity through such fuel inlet port 238, then to a vacuum position where the carriage aperture 204 is open to the vacuum port 244 and gas (e.g. air or atmospheric air) is removed from the inner carriage cavity through the vacuum port 244, and then to a reactor port position where the carriage aperture 204 is open to the reactor port 220 and the plurality of fuel particles in the fuel carriage 202 is directed by gravity or other force through the carriage aperture 204 and out the reactor port 220. The seal positions and relative dimensions and positions of the carriage aperture 204 and ports (vacuum port 244, fuel inlet port 238, reactor port 220) are configured to allow sequential movement to maintain the vacuum created by the vacuum step when translating the carriage body 202 between the vacuum position and the reactor port position.

For example in the embodiment of FIG. 2B, the seal proximal (on the right side of FIG. 2B along the longitudinal axis of the transfer tube) to the carriage aperture 204 (i.e. seal formed by the first sealing member 230 and/or third sealing member 234) is positioned between the vacuum port 244 and the fuel inlet port 238 (longitudinally) when vacuum is applied to the inner carriage cavity contents, and then the proximal seal is moved distally to a position between the vacuum port 244 and the reactor port 220 (distally toward distal seals 228, 232 along the longitudinal axis of the transfer tube 208). In some embodiments, such as that shown in FIG. 2B, the fuel carriage 202 is also rotatable such that the carriage aperture 204 moves to the reactor port position which is a second location along a longitudinal axis of the transfer tube relative to the vacuum port 244. In some embodiments, the reactor port 220 is positioned such that gravity moves the fuel from inside the fuel carriage 202 through the carriage aperture 204 and reactor port 220 when such carriage aperture 204 and reactor port 220 are aligned axially and longitudinally. In some embodiments, the vacuum port 244 pumps an inert gas into the fuel carriage 202 after removal of some or all of the air within the fuel carriage 202, for example at least 80%, 90%, at least 95%, 96%, 97%, 98%, 99%, 99.5%, 99.9%, 99.95% and/or up to 100% of the air or of the oxygen in the fuel carriage. In some embodiments, a second linear actuator (not shown) couples with the fuel carriage 206 and is configured to control the orientation (i.e., angle) of rotation about the longitudinal axis of the fuel carriage 206. In some embodiments, the second actuator is configured to rotate the piston 226, therefore turning the fuel carriage 206. In some embodiments, the first linear actuator and the second linear actuator are used in combination to provide control of movement for the fuel carriage 206 along the longitudinal axis and about the longitudinal axis of the transfer tube 208.

In some embodiments, the first linear actuator is configured to control the movement of the piston 226 both forward and backwards along a longitudinal axis of the fuel carriage. In some embodiments, the first linear actuator is a lead screw, ball screw, rack and pinion, or any other linear actuator configured to convert the rotational movement of a rotary motor to linear movement. In some embodiments, the first linear actuator is an electric linear actuator. In some embodiments, the first linear actuator is driven by a hydraulic cylinder coupled to a hydraulic power unit and appropriate fluidic valving. In some embodiments, the first linear actuator is driven by a pneumatic system coupled to a compressor, reservoir, and appropriate valving. In some embodiments, the position of the piston 226 is determined by position sensors such as reed switches, optical sensors, capacitive sensors, or any combination thereof. In some embodiments, the position of the piston 226 is determined by a sensor coupled with a rotary motor, whereby the rotation of a rotary motor is counted per each rotation as a step counter. In some embodiments, the steps are counted on a stepper motor coupled to a lead screw.

In some embodiments, a microcontroller or other electronic circuit is configured to control the linear movement and speed of the first linear actuator and the piston 226. In some embodiments, a signal from the microcontroller is determined by a sensor coupled with a processor based on vacuum pressure achieved in any region of the continuous aluminum-water reactor system 100, any state of an auxiliary unit such as a device depositing fuel into the fuel carriage 202, any state of the reactor vessel 102 such as the internal pressure, temperature, output power output, or any combination of two or more thereof.

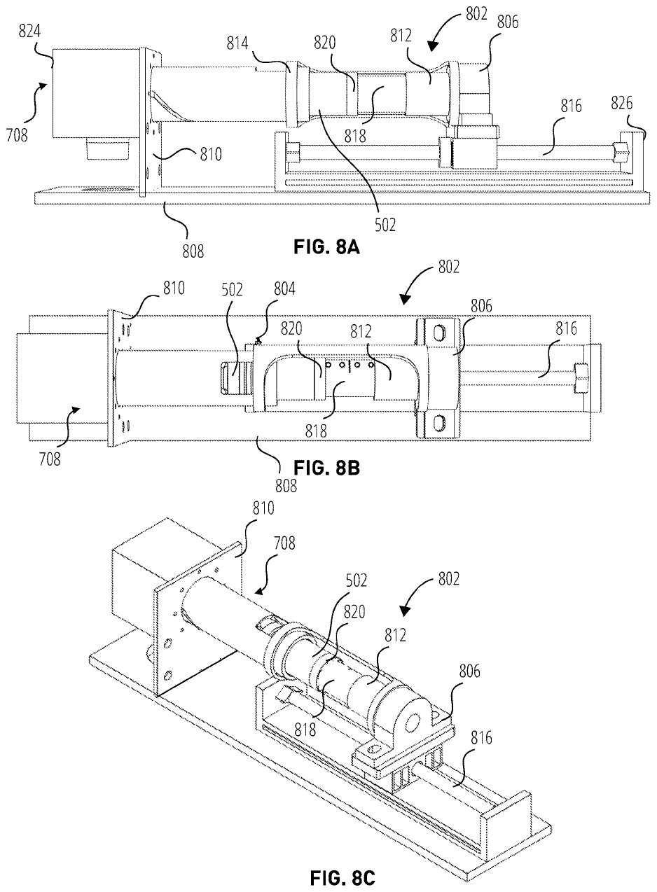

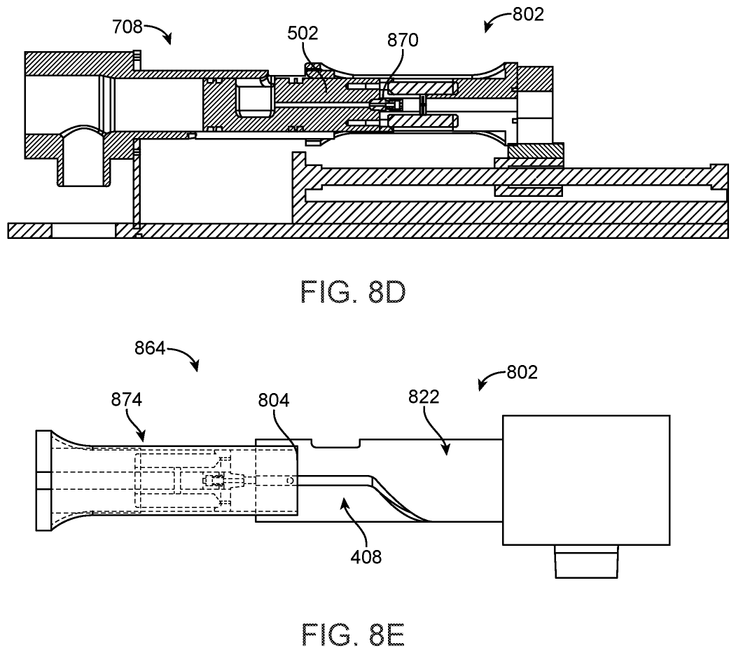

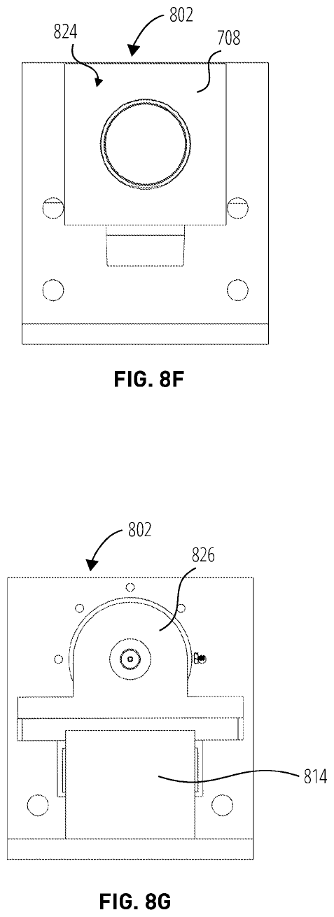

In some embodiments, a barrel cam mechanism (see FIG. 4 and FIG. 8E) is coupled to the outer cylindrical surface of the carriage body 202 and configured to translate linear motion into rotational motion to rotate the carriage aperture 204 down to align with the reactor port cavity 242. In some embodiments, the barrel mechanism includes the carriage body 202 as a rotating barrel-shaped cam and a follower that moves along the surface of the carriage body 202. In some embodiments, the track is at least partially disposed in the outer cylindrical surface of the carriage body 202 and configured to couple with the follower portion of a barrel cam mechanism. In some embodiments, the track includes at least one linear track portion and at least one turn track portion. In some embodiments, the carriage body 202 is configured to travel within the transfer tube passageway 218 and along the longitudinal axis of the carriage body 202 when the follower is aligned with a linear track portion. In some embodiments, the carriage body 202 is configured to move within the transfer tube passageway 218 and rotate about the longitudinal axis of the carriage body 202 when the follower is aligned with a turn track portion. In some embodiments, the transfer tube passageway 218 of the transfer tube 208, includes one or more rollers configured to guide the piston 226 and prevent jamming of the piston 226 against the transfer tube passageway 218.

FIG. 2D illustrates the fuel loading apparatus 200 of FIG. 2A positioned in a reactor loading position, according to an embodiment herein.

In some embodiments, when the fuel loading apparatus 200 is in the reactor loading position, the carriage aperture 204 is positioned to face the reactor port cavity 242. In some embodiments, the reactor port 220 is configured as a passageway to deposit fuel from the carriage cavity of the carriage body 202 into a reactor vessel. In some embodiments, the fuel is deposited through the reactor port 220 and into a reactor vessel by gravity and/or pressure. In some embodiments, the reactor port 220 and the fuel inlet port 238 extend in opposite directions from the transfer tube wall 214. In some embodiments, the reactor port 220 is located in closer proximity to a transfer tube dead end 216 than the fuel inlet port 238.

In some embodiments, the fuel loading apparatus 200 is configured to continuously and cyclically move from a loading position shown in FIG. 2A, to an air evacuation shown in FIG. 2B, to a transfer position shown in FIG. 2C, to a fuel loading position shown in FIG. 2D to continuously add fuel to the reactor vessel 102 from the fuel loading apparatus 200. In some embodiments, fuel is loaded into the reactor vessel 102 by the fuel loading apparatus 200 while the reactor is actively running.

In some embodiments, a plurality of fuel loading apparatuses is coupled to a single continuous aluminum-water reactor system 100. In some embodiments, one or more additional fuel loading apparatuses are configured to increase the effective fueling frequency to the reactor vessel 102 without decreasing the cycle time of any individual fuel loading apparatus 200. In some embodiments, the plurality of fuel loading apparatuses is configured to have the same components and operate using the same mechanism of motion. In some embodiments, the plurality of fuel loading apparatuses is configured to have different components and operate using the different mechanisms of motion. In some embodiments, each fuel loading apparatus in a plurality of fuel loading apparatuses is configured to deliver the same volume or mass of fuel to the reactor. In some embodiments, a first fuel loading apparatus in a plurality of fuel loading apparatus 200 is configured to deliver a different volume or mass of fuel to the reactor than a second fuel loading apparatus of the plurality of fuel loading apparatuses.

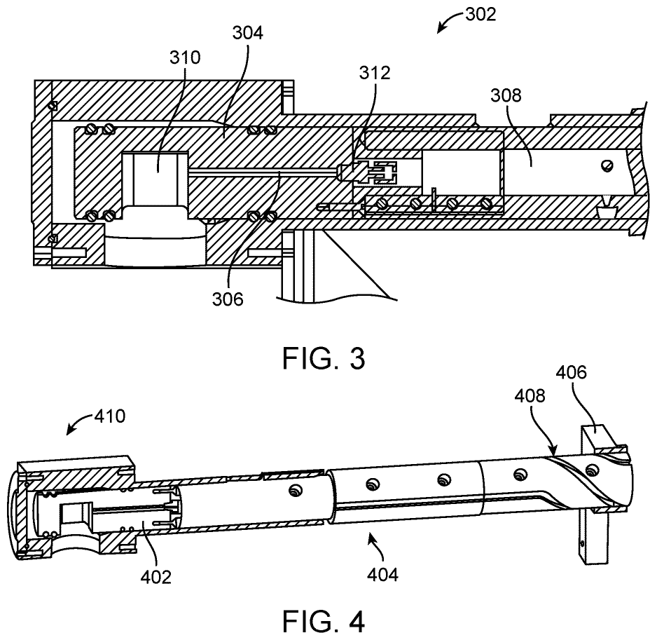

FIG. 3 illustrates an embodiment of the fuel loading apparatus 302 having a fuel carriage 304 comprising a vacuum port 306 configured for evacuating air in a direction generally parallel with the axis of motion of the piston assembly 308. In some embodiments, the vacuum port 306 extends through the fuel carriage 304 from an inner carriage cavity 310 to a gas coupling 312, wherein the vacuum port 306 extends in a direction parallel to the longitudinal axis of the fuel carriage 304. In some embodiments, the vacuum port 306 is connected to a gas coupling 312 to ensure a complete vacuum seal between the fuel carriage 304 and the piston assembly 308.

FIG. 4 illustrates a side view of an embodiment of the fuel carriage 402 configured to have a non-stationary piston assembly 404 coupled with a stationary element 406 to convert linear motion into rotational motion of the non-stationary piston assembly 404 and the fuel carriage 402. In some embodiments, the non-stationary piston assembly 404 has a rotary cam profile 408 on the outer surface of the non-stationary piston assembly 404. In some embodiments, the rotary cam profile 408 is machined or otherwise manufactured into the outer surface of the non-stationary piston assembly 404. In some embodiments, the stationary element 406 is configured to hold a cam follower element in the rotary cam profile 408 of the non-stationary piston assembly 404. Upon relative motion between the cam follower element and the rotary cam profile 408, rotation of the non-stationary piston assembly 404 and fuel carriage 402 is initiated. In some embodiments, the stationary element 406 may be directly connected to the stationary transfer tube 208.

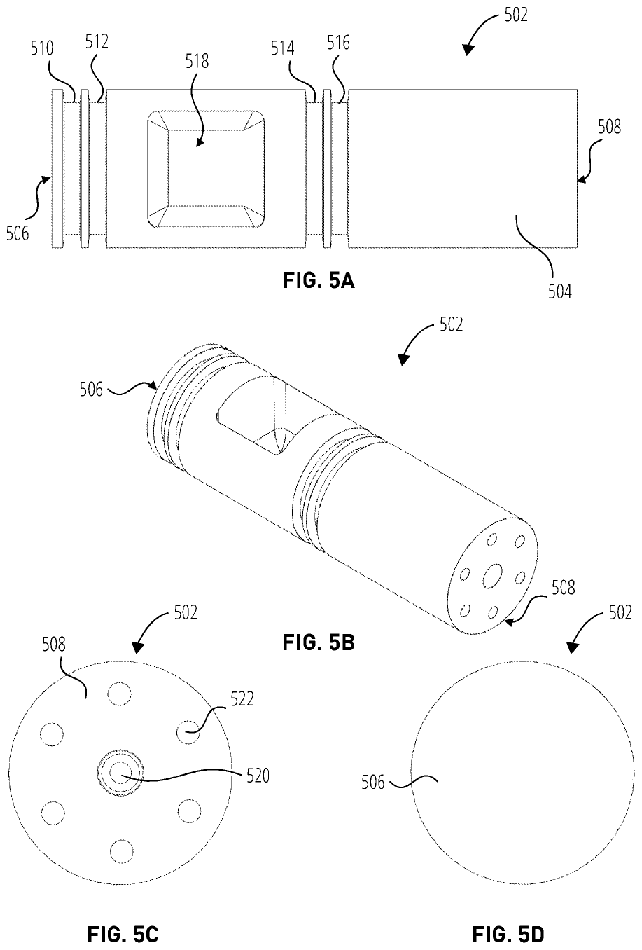

FIG. 5A illustrates a top-down view of a fuel carriage 502. In some embodiments, the fuel carriage 502 is defined by a carriage body 504 extending from a first end 506 to a second end 508. In some embodiments, the fuel carriage 502 is configured to have a first groove 510, a second groove 512, a third groove 514, and a fourth groove 516 at least partially recessed into the carriage body 504. In some embodiments, the first groove 510, the second groove 512, the third groove 514, and the fourth groove 516 are spaced apart from one another. In some embodiments, the first groove 510, the second groove 512, the third groove 514, and the fourth groove 516 are disposed around the entire circumference of the carriage body 504. In some embodiments, the first groove 510 and second groove 512 are configured to couple with O-rings and form an airtight seal between the first end 506 and the second end 508. In some embodiments, the third groove 514 and the fourth groove 516 are configured to couple with O-rings and form an airtight seal between the first end 506 and the second end 508. In some embodiments, the third groove 514 and the fourth groove 516 are configured to couple with O-rings and form an airtight seal between the outer walls of the first groove 510 and outer walls of the fourth groove 516. In some embodiments, the fuel carriage 502 is configured to have a carriage aperture 518 disposed between the second groove 512 and the third groove 514. In some embodiments, the carriage aperture 518 is configured to receive fuel pellets when the fuel carriage 502 is in the loading position. In some embodiments, the carriage aperture 518 is configured to dispense fuel pellets into a reactor chamber when the fuel carriage 502 is in the dispensing position.

FIG. 5B illustrates an isometric view of the fuel carriage 502 shown in FIG. 5A. In some embodiments, the fuel carriage 502 is cylindrical in shape. In some embodiments, the fuel carriage 502 is configured to fit within a transfer tube. In some embodiments, the fuel carriage 502 is configured to slidably move within the transfer tube.

FIG. 5C illustrates a front view of the fuel carriage 502 shown in FIG. 5A from a perspective viewing the second end 508. In some embodiments, the second end 508 is configured to have a gas vacuum port 520 disposed through the center of the second end 508 and extending inward along a longitudinal axis of the fuel carriage. In some embodiments, the gas vacuum port 520 extends through the carriage body 504 along the longitudinal axis to the carriage aperture 518. In some embodiments, the fuel carriage 502 has a mounting hole 522 disposed at least partially through the surface of the second end 508. In some embodiments, the mounting hole 522 is configured to couple with a piston assembly (not shown) so as to couple the fuel carriage 502 with the piston assembly. In some embodiments, the second end 508 has one mounting hole 522. In some embodiments, the second end 508 is configured with one, two, three, four, five, six, or more than six mounting holes 522. In some embodiments, the mounting holes 528 are configured symmetrically about the longitudinal axis of the fuel carriage 502. In some embodiments, the mounting holes 522 are spaced apart from one another and the gas vacuum port 520.

FIG. 5D illustrates an example of a back view of the fuel carriage 502 shown in FIG. 5A from a perspective viewing the first end 506. In some embodiments, the first end 506 comprises a solid surface.

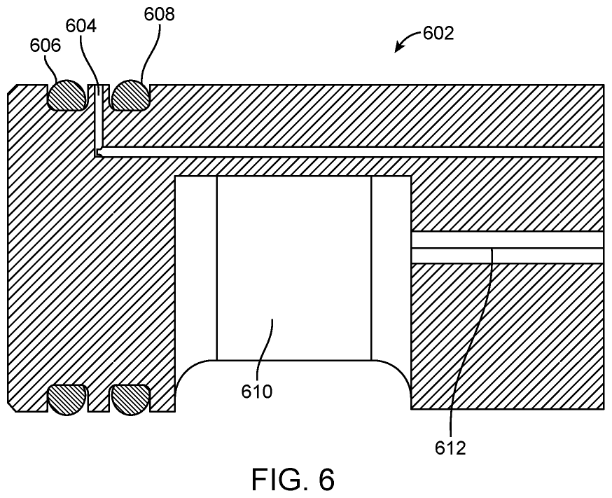

FIG. 6 illustrates a cross-sectional view of an exemplary fuel carriage 602 having a channel 604 disposed between a first sealing member 606 and a second sealing member 608. In some embodiments, the first sealing member 606 is configured to form a first seal between the fuel carriage 602 and a transfer tube assembly, and the second sealing member 608 is configured to form a second seal between the fuel carriage 602 and the transfer tube assembly. In some embodiments, the channel 604 comprises a first portion extending radially inwards from the exterior surface of the fuel carriage 602 towards the longitudinal axis of the fuel carriage 602. In some embodiments, the channel 604 comprises a first portion extending radially inwards from the exterior surface of the fuel carriage 602 towards the longitudinal axis of the fuel carriage 602 and a second portion extending from the first portion in a direction parallel to the longitudinal axis of the fuel carriage 602 thereby forming a substantially “L” like shape. In some embodiments, the channel 604 is spaced apart from and not in fluid communication with the inner carriage cavity.

In some embodiments, the fuel carriage 602 comprises a channel 604 extending between the first sealing member 606 and the second sealing member 608 or between a third sealing member and a fourth sealing member (see, e.g., FIG. 2A). In some embodiments, the channel 604 has a pressure which is greater than, less than, or between a reactor pressure and an inlet pressure. In some embodiments, the channel pressure is configured to equilibrate to either the reactor pressure or the inlet pressure upon failure of at least one of the first seal, the second seal, the third seal, and the fourth seal.

In some embodiments, the channel 604 is coupled with a sensor (not shown). In some embodiments, the sensor is configured to indicate if the pressure within the channel 604 has changed. For example, the sensor may indicate pressure in the channel 604 has dropped below a desired pressure level so as to indicate a reduction in effectiveness of the first sealing member 606 and/or second sealing member 608.

For example, the sensor may detect the pressure within the channel 604 and the location of the fuel carriage 602 within the transfer tube 702. In some embodiments, when the inner carriage cavity 610 is aligned with the fuel inlet 704, the channel 604 will equilibrate to the pressure of the fuel fed into the inner carriage cavity 610 (e.g., ambient pressure). In some embodiments, when the inner carriage cavity 610 is aligned with the reactor port 706 the pressure the channel 604 will equilibrate to the pressure of the reactor. In some embodiments, one or more sensors detect the pressure within the channel 604 and the position of the fuel carriage 602 within the transfer tube 702. In some embodiments, the one or more sensors relay the detected pressure within the channel 604 and location of the fuel carriage 602 within the transfer tube 702 to a processor. In some embodiments, the processor compares the detected pressure within the channel 604 and the location of the fuel carriage 602 within the transfer tube 702 to a desired pressure associated with a location of the fuel carriage 602 within the transfer tube 702. In some embodiments, the processor is configured to relay a signal indicating failure if the detected pressure determined by a sensor at a particular location surpasses a threshold desired pressure associated with that location to indicate a reduction in effectiveness of the first sealing member 606 and/or second sealing member 608. In some embodiments, the channel is disposed between the third groove 514 and fourth groove 516 as shown in FIG. 5A and FIG. 5B.

In some embodiments, a sensor is coupled with a vacuum port 612. In some embodiments, the sensor is configured to indicate if the pressure within the inner carriage cavity 610 has changed. For example, the sensor may indicate pressure in the channel 604 has dropped below a desired pressure level so as to indicate a reduction in effectiveness of the first sealing member 606 and/or second sealing member 608. In some embodiments, the fuel carriage 602 is used in the fuel loading apparatus 104, the fuel loading apparatus 200, fuel loading apparatus 302, the fuel loading apparatus 410, or any other fuel loading apparatus described herein.

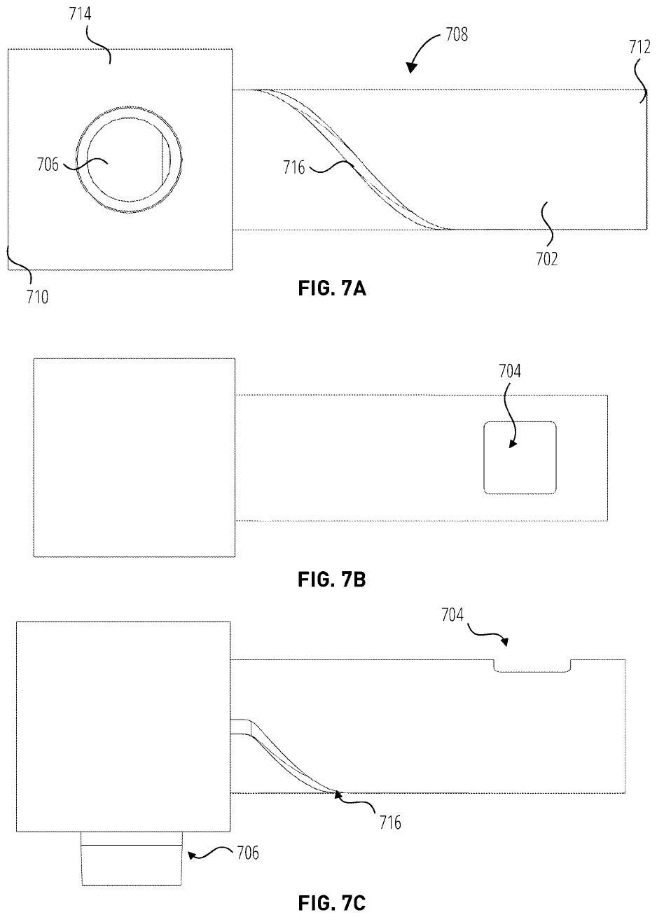

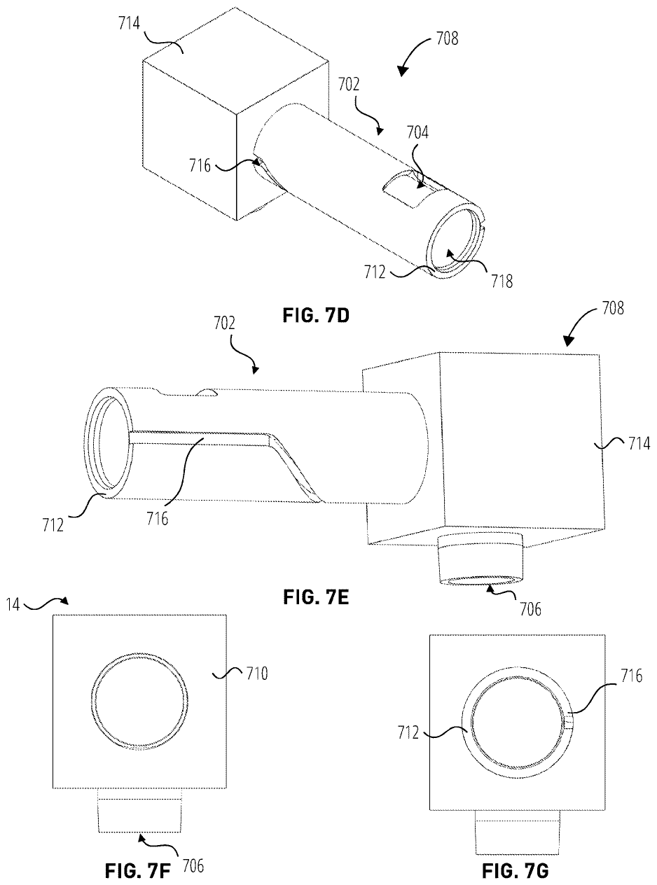

FIG. 7A illustrates a bottom up view of a transfer assembly 708. In some embodiments, the transfer assembly 708 is configured to have a first end 710 and a second end 712 spaced apart by a transfer tube 702 and a transfer housing 714. In some embodiments, the transfer tube 702 is fixedly coupled to the transfer housing 714. In some embodiments, the transfer tube 702 is configured to house and guide a fuel carriage along an axis of movement. In some embodiments, the transfer tube 702 is configured to have a groove 716 that spirals at least partially around the transfer tube 702. In some embodiments, the groove 716 extends from the second end 712 to the transfer housing 714. In some embodiments, the groove 716 is configured to guide a cam follower of the fuel carriage and create rotation of the fuel carriage as the fuel carriage travels through the transfer tube 702 towards the transfer housing 714.

In some embodiments, the transfer housing 714 is configured to have a reactor port 706 on the underside of the transfer housing 714. In some embodiments, the transfer housing reactor port 706 is coupled to a funnel and/or a tube (not shown) configured to couple with a reactor chamber (not shown). In some embodiments, the reactor port 706 is configured to dispose a plurality of fuel particles to pass into the reactor chamber through the funnel when the fuel carriage in the fuel dispensing position.

FIG. 7B illustrates a top down view of the transfer assembly 708 shown in FIG. 7A. In some embodiments, the transfer tube 702 is configured to have a fuel inlet 704 disposed though the top surface of the transfer tube 702. In some embodiments, the fuel inlet 704 is square in shape. In some embodiments, the fuel inlet 704 is rectangular in shape. In some embodiments, the fuel inlet 704 is circular in shape. In some embodiments, the fuel inlet 704 has rounded corners and/or edges configured to prevent blockages as fuel pellets as they pass through the fuel inlet 704 into the fuel carriage.

FIG. 7C illustrates a side-on view of the transfer assembly 708 shown in FIG. 7A. In some embodiments, the reactor port 706 extends distally beyond the bottom surface of the transfer housing 714. In some embodiments, the reactor port 706 is flush with the bottom surface of the transfer housing 714. In some embodiments, the reactor port 706 extends to a location proximal to the bottom surface of the transfer housing 714. In some embodiments, the reactor port 706 is threaded and configured to facilitate coupling with a funnel and/or a tube (not shown). In some embodiments, the outer walls of the reactor port 706 taper inwards along the longitudinal axis. In some embodiments, the outer walls of the reactor port 706 are straight along the longitudinal axis. In some embodiments the bottom surface of transfer housing 714 is coupled to a funnel, a tube, and/or another component configured to convey of fuel to a reactor chamber. In some embodiments, a mechanical coupling such as a fasteners is configured to couple the bottom surface of transfer housing 714 with a reactor.

FIG. 7D illustrates an isometric view of the transfer assembly 708 shown in FIG. 7A from above. In some embodiments, the groove 716 extends from a first end of the transfer tube 702 interfacing with the transfer housing 714 to the second end 712. In some embodiments, the groove 716 partially passes through the exterior surface of the transfer tube 702 but not through to the transfer tube bore 718. In some embodiments, the groove 716 extends through the 702 to the transfer tube bore 718. In some embodiments, the transfer tube bore 718 extends at least partially through the transfer tube 702. In some embodiments, the transfer tube bore 718 extends entirely through the transfer tube 702.

FIG. 7E illustrates an isometric view of the transfer assembly 708 shown in FIG. 7A from a perspective below. In some embodiments, the groove 716 has a first portion which extends from the second end 712 in a direction parallel to the longitudinal axis of the transfer tube 702 and a second portion extending from the first portion which spirals around the transfer tube 702 to the transfer housing 714. In some embodiments, a reactor port 706 extends from the transfer housing 714.

FIG. 7F illustrates an axial view of the transfer assembly 708 shown in FIG. 7A from a perspective viewing a first end 710. In some embodiments, a reactor port 706 extends from the transfer housing 714.

FIG. 7G illustrates an axial view of the transfer assembly 708 shown in FIG. 7A from a perspective viewing a second end 712. In some embodiments, the groove 716 is disposed through a surface of the second end 712.

FIG. 8A, FIG. 8B, FIG. 8C, and FIG. 8G illustrate views for the assembled fuel loading apparatus 802 of FIG. 8A from side, top, isometric, and planar cross-sectional perspectives respectively. In this view, the fuel carriage 502 is disposed within the transfer assembly 708.

In some embodiments, a cam follower 804 is attached to the fuel carriage 502 and placed within the groove 716 of the transfer assembly 708. In some embodiments, when the fuel carriage 502 is moved by the piston guide rail mount 806, the interface of the cam follower 804 and the groove 716 cause the fuel carriage 502 to rotate about the longitudinal axis if the fuel carriage 502.

In some embodiments, the fuel loading apparatus 802 comprises a transfer assembly 708 and a fuel carriage 502. In some embodiments, the fuel loading apparatus 802 is configured to couple with a fuel loading apparatus mounting plate 808. In some embodiments, the fuel loading apparatus mounting plate 808 extends along the entire length of the fuel loading apparatus 802.

In some embodiments, the fuel loading apparatus mounting plate 808 is configured to couple with a reactor vessel (not shown) such that the fuel loading apparatus 802 is held in place relative to the reaction vessel. In some embodiments, the fuel loading apparatus mounting plate 808 is configured to include a transfer assembly mount 810. In some embodiments, the transfer assembly mount 810 comprises an opening configured to stabilize at least a portion of the transfer tube 702 of the transfer assembly 708.

In some embodiments, the transfer assembly 708 and the fuel carriage 502 are disposed within the fuel loading apparatus 802 such that the fuel carriage 502 is aligned along the longitudinal axis of the transfer assembly 708 to slide laterally within the transfer assembly 708 along the longitudinal axis of the transfer assembly 708.

In some embodiments, the piston 812 is coupled to a piston guide frame 814 such that the piston 812 is aligned with a piston guide rail mount 806 along the longitudinal axis. In some embodiments, when the piston 812 is coupled to the piston guide frame 814 and the piston guide rail mount 806 it is configured such that it freely rotates about the longitudinal axis.

In some embodiments, the piston guide frame 814 is configured such that at the end opposite the piston 812 there is an opening capable of allowing the piston guide frame 814 to pass over the top of the transfer assembly 708. In some embodiments, the piston guide rail mount 806 is configured to interface with a piston guide rail 816. In some embodiments, the piston guide rail mount 806 slides freely parallel to the longitudinal axis of the piston guide rail 816. In some embodiments, the sliding motion is powered by an electric motor, pneumatics, hydraulics, or a combination of two or more thereof.

In some embodiments, when the piston guide rail mount 806 slides along the piston guide rail 816 it moves the bodies it is coupled with as well. For example, the piston guide rail mount 806, piston 812, piston guide frame 814, piston coupling 818, vacuum port coupling 820, and the fuel carriage 502 would all move in concert when the piston guide rail mount 806 slid along the piston guide rail 816. In some embodiments, the fuel carriage 502, vacuum port coupling 820, piston coupling 818, and the piston 812 are configured to slide within the transfer assembly 708, while the piston guide frame 814 is configured to slide over the outside of the transfer assembly 708.

FIG. 8E illustrates a side and transparent view of an embodiment of the fuel loading apparatus 802 configured to have a stationary cam profile element 822 coupled with a cam follower 804. In some embodiments, the cam follower 804 is attached to the non-stationary piston assembly 404. In some embodiments, the stationary cam profile element 822 is configured with the rotary cam profile 408 on the outer surface of the stationary cam profile element 822. In some embodiments, the rotary cam profile 408 is machined or otherwise manufactured into the outer surface of the stationary cam profile element 822. Upon relative motion of the cam follower 804 coupled with the rotary cam profile 408 and the stationary cam profile element 822, rotation of the non-stationary piston assembly 404 and the fuel carriage 502 is initiated.

FIG. 8F and FIG. 8G illustrate axial views of the first end 824 and the second end 826 of the fuel loading apparatus 802 of FIG. 8A, respectively. FIG. 8F illustrates a portion of the transfer assembly 708. FIG. 8J illustrates the piston guide frame 814.

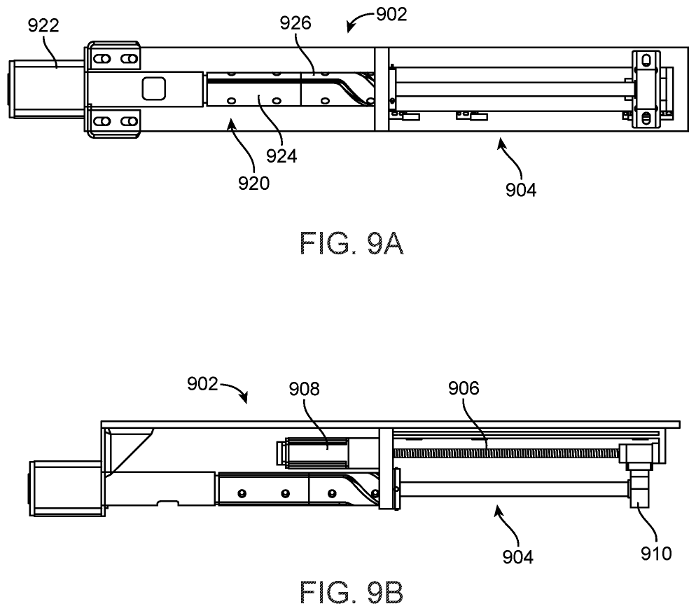

FIG. 9A and FIG. 9B illustrate top and side views of a fuel loading apparatus 902, respectively. In some embodiments, the piston assembly 904 comprises a piston guide rail 906. In some embodiments, the piston guide rail 906 is threaded. In some embodiments, the piston assembly 904 comprises an actuator 908 coupled with the piston guide rail 906 such that when the actuator 908 rotates the piston guide rail 906 about its longitudinal axis, a mount 910 moves parallel to the longitudinal axis of the piston guide rail 906. In some embodiments, the actuator 908 is an electric stepper motor.

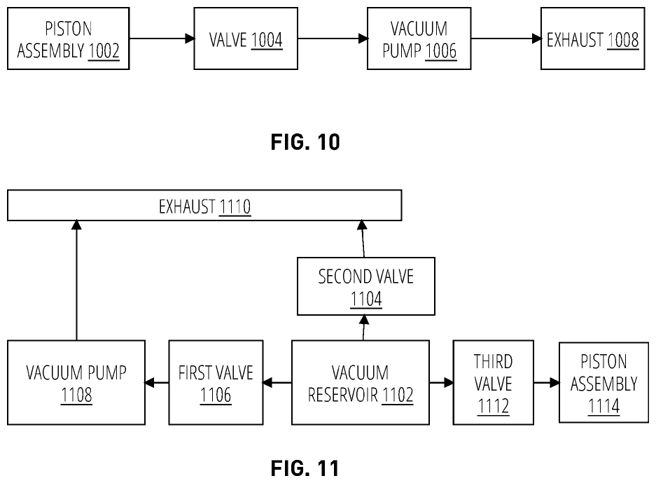

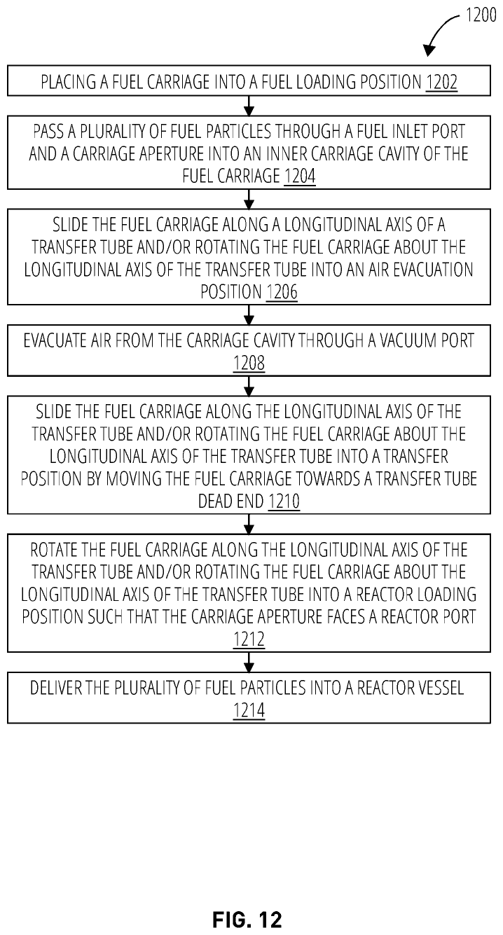

FIG. 10 illustrates an exemplary diagram of a piston assembly 1002 coupled with a vacuum pump 1006 according to embodiments described herein. In some embodiments, a valve 1004 is configured to couple the piston assembly 1002 with the vacuum pump 1006. In some embodiments, the valve 1004 is configured to transition from an open configuration where the piston assembly 1002 is in fluid communication with the vacuum pump 1006 and a closed configuration where the piston assembly 1002 is not in fluid communication with the vacuum pump 1006. In some embodiments, the vacuum pump 1006 is coupled to an exhaust 1008 so as to release fluid from the vacuum pump 1006. For example, the fluid may be air pulled from the piston assembly 1002 by the vacuum pump 1006 and exited through the exhaust 1008.

In some embodiments, the valve 1004 is a solenoid valve. In some embodiments, valve 1004 is a collapsible valve. In some embodiments, valve 1004 is selected from a group consisting of a ball valve, a butterfly valve, a globe valve, a plug valve, a check valve, a needle valve, a pinch valve, a diagram valve, a solenoid valve, and a pressure relief valve.

FIG. 11 illustrates an exemplary diagram of a piston assembly 1114 coupled with a vacuum reservoir 1102 according to embodiments described herein. In some embodiments, a vacuum pump 1108 is coupled to a vacuum reservoir 1102 with a first valve 1106 disposed between to allow for non-continuous exposure of the vacuum reservoir 1102 to vacuum. In some embodiments, when the vacuum reservoir 1102 reaches a suitable vacuum pressure the vacuum pump 1108 could be, but need not be, de-energized. In some embodiments, the vacuum reservoir 1102 is further coupled to an exhaust 1110 with a second valve 1104 disposed between. In some embodiments, the vacuum reservoir 1102 is further coupled to a piston assembly 1114 with a third valve 1112 disposed between. In some embodiments, the vacuum reservoir 1102 is in fluid communication with the piston assembly 1114 when the third valve 1112 is opened, allowing the piston assembly 1114 to vent into the vacuum reservoir 1102. In some embodiments, the vacuum reservoir 1102 vents to the exhaust 1110 when the second valve 1104 is opened. This configuration allows for the piston assembly 1114 to be vented without the vacuum pump 1108 being exposed to the gases from the piston assembly 1114.

In some embodiments, at least one of the first valve 1106, the second valve 1104, and the third valve 1112 is a solenoid valve. In some embodiments, the first valve 1106, the second valve 1104, and the third valve 1112 are each solenoid valves. In some embodiments, the first valve 1106, the second valve 1104, and the third valve 1112 are selected from a group consisting of a ball valve, a butterfly valve, a globe valve, a plug valve, a check valve, a needle valve, a pinch valve, a diagram valve, a solenoid valve, and a pressure relief valve, or any combination of two or more thereof.

In block 1202, method 1200 places a fuel carriage into a fuel loading position. In block 1204, method 1200 passes a plurality of fuel particles through a fuel inlet port and a carriage aperture into an inner carriage cavity of the fuel carriage. In block 1206, method 1200 slides the fuel carriage along a longitudinal axis of a transfer tube and/or rotating the fuel carriage about the longitudinal axis of the transfer tube into an air evacuation position. In block 1208, method 1200 evacuates air from the carriage cavity through a vacuum port. In block 1210, method 1200 slides the fuel carriage along the longitudinal axis of the transfer tube and/or rotating the fuel carriage about the longitudinal axis of the transfer tube into a transfer position by moving the fuel carriage towards a transfer tube dead end. In block 1212, method 1200 rotates the fuel carriage along the longitudinal axis of the transfer tube and/or rotating the fuel carriage about the longitudinal axis of the transfer tube into a reactor loading position such that the carriage aperture faces a reactor port. In block 1214, method 1200 delivers the plurality of fuel particles into a reactor vessel.

Certain examples of the present disclosure were described above. It is, however, expressly noted that the present disclosure is not limited to those examples, but rather the intention is that additions and modifications to what was expressly described herein are also included within the scope of the disclosed examples. Moreover, it is to be understood that the features of the various examples described herein were not mutually exclusive and may exist in various combinations and permutations, even if such combinations or permutations were not made express herein, without departing from the spirit and scope of the disclosed examples. In fact, variations, modifications, and other implementations of what was described herein will occur to those of ordinary skill in the art without departing from the spirit and the scope of the disclosed examples. As such, the disclosed examples are not to be defined only by the preceding illustrative description.

In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

The foregoing description of examples has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A fuel loading apparatus comprising:
a transfer tube comprising a transfer tube first end, a transfer tube second end, and a transfer tube wall therebetween defining a transfer tube passageway;
a fuel inlet port in fluid communication with the transfer tube passageway;
a vacuum port in fluid communication with the transfer tube passageway;
a reactor port in fluid communication with the transfer tube passageway; and
a fuel carriage disposed within the transfer tube passageway comprising:
(a) a carriage body having an outer carriage surface, an inner carriage cavity, and a carriage wall therebetween;
(b) a first sealing member is disposed around the outer carriage surface and configured to form a first seal between the outer carriage surface and an inner surface of the transfer tube passageway,
(c) a second sealing member disposed around the outer carriage surface and configured to form a second seal between the outer carriage surface and the inner surface of the transfer tube passageway, and
(d) a first carriage aperture through the carriage wall and positioned between the first sealing member and the second sealing member creating fluid communication between the carriage cavity and the transfer tube passageway.

2. The fuel loading apparatus of claim 1, further comprising:
a third sealing member disposed around the outer carriage surface and configured to form a third seal between the outer carriage surface and the inner surface of the transfer tube passageway; and
a fourth sealing member disposed around the outer carriage surface and configured to form a fourth seal between the outer carriage surface and the inner surface of the transfer tube passageway, wherein the first carriage aperture is positioned between the third sealing member and the fourth sealing member.

3. The fuel loading apparatus of claim 2, wherein the first sealing member and the third sealing member are configured to form the first seal and the third seal on a first side of the first carriage aperture and the second sealing member and the fourth sealing member are configured to form the second seal and the fourth seal on a second side of the first carriage aperture which is opposite to the first side relative to the carriage aperture thereby forming a double sealed airlock.

4. The fuel loading apparatus of any one of claims 1 to 3, wherein the vacuum port is coupled to a pump configured to evacuate air within a carriage cavity when the first carriage aperture is facing said vacuum port.

5. The fuel loading apparatus of any one of claims 2 to 4, wherein at least one of first, second, third, and fourth sealing members is configured to form and maintain a seal between a reactor vessel and an outside environment.

6. The fuel loading apparatus of any one of claims 1 to 5, wherein the reactor port comprises a fuel feed hopper.

7. The fuel loading apparatus of any one of claims 1 to 6, wherein the fuel inlet port and the reactor port extend from the transfer tube wall in opposite directions.

8. The fuel loading apparatus of any one of claims 1 to 7, wherein the vacuum port is located between the fuel inlet port and the reactor port.

9. The fuel loading apparatus of any one of claims 1 to 8, wherein the fuel carriage further comprises a piston extending a first end of the carriage to a piston free end configured to rotate the fuel carriage.

10. The fuel loading apparatus of claim 9, wherein the piston and the carriage body are coaxially aligned along a longitudinal axis of the fuel carriage.

11. The fuel loading apparatus of claim 9 or 10, wherein the piston is coupled with an actuator and a guide rail so as to move the piston between a first position and a second position along a longitudinal axis of the fuel loading apparatus.

12. The fuel loading apparatus of claim 11, wherein the guide rail is threaded.

13. The fuel loading apparatus of any one of claims 1 to 12, further comprising a cam barrel mechanism configured to translate the fuel carriage along and/or about a longitudinal axis of the transfer tube.

14. The fuel loading apparatus of any one of claims 1 to 13, further comprising at least one actuator configured to translate the fuel carriage along and/or rotate the fuel carriage about a longitudinal axis of the transfer tube.

15. The fuel loading apparatus of any one of claims 1 to 14, wherein the fuel carriage is configured to receive a plurality of fuel particles having particle sizes greater than one centimeter.

16. The fuel loading apparatus of any one of claims 1 to 15, wherein the transfer tube further comprises a transfer tube dead end configured to at least partially receive the fuel carriage.

17. The fuel loading apparatus of claim 16, wherein the transfer tube dead end aligns the fuel carriage along a longitudinal axis of the transfer tube and/or rotate about the longitudinal axis of the fuel carriage with the reactor port such that the carriage aperture is aligned with the reactor port cavity.

18. The fuel loading apparatus of any one of claims 1 to 17, wherein the first sealing member and the second sealing member are spaced apart at a distance further than the vacuum port and/or carriage aperture.

19. The fuel loading apparatus of any one of claims 1 to 18, wherein the fuel carriage has at least one freedom of movement relative to a transfer tube or a portion thereof.

20. The fuel loading apparatus of claim 19, where the freedom of movement is axial translation within the transfer tube or relative to the ports thereof, rotational movement relative to the transfer tube or relative to the ports thereof, or a combination of axial translation and rotational movement relative to the transfer tube or relative to the ports thereof.

21. The fuel loading apparatus of any one of claims 1 to 20, wherein the fuel carriage comprises a port extending from the inner cavity through the outer carriage surface, wherein the port is configured to couple with a vacuum port coupling so as to evacuate a fluid within the inner cavity.

22. The fuel loading apparatus of claim 21, wherein the port extends along a longitudinal axis of the fuel carriage.

23. The fuel loading apparatus of any one of claims 1 to 21, wherein the pressure in the reactor vessel is greater than or less than ambient pressure.

24. The fuel loading apparatus of any one of claims 1 to 21, wherein the fuel carriage comprises a channel extending between the first sealing member and a second sealing member and/or between the third sealing member and a fourth sealing member, wherein the channel has a pressure which is greater than, less than, or between a reactor pressure and an inlet pressure, wherein the pressure in the channel is configured to equilibrate to either the reactor pressure or the inlet pressure upon at least partial failure of at least one of the first seal, the second seal, the third seal, and the fourth seal.

25. The fuel loading apparatus of claim 24, wherein the channel coupled with one or more sensors configured to detect the pressure within the channel and, optionally the location of the fuel carriage within the transfer tube.

26. A system comprising a processor and the fuel loading apparatus of claim 25, wherein:
the one or more sensors configured to relay the detected pressure within the channel and/or and location of the fuel carriage within the transfer tube to the processor,
the processor is configured to compare the detected pressure within the channel and the location of the fuel carriage within the transfer tube to a desired pressure associated with a correlated location of the fuel carriage within the transfer tube; and
the processor is configured to relay a signal to indicate failure if the detected pressure determined by the sensor at the location is above or below a predetermined desired threshold pressure associated with that correlated location to indicate a reduction in effectiveness of the first seal and/or the second seal.

27. The system comprising of claim 26, wherein the indication of a reduction in effectiveness of the first seal and/or the second seal is an audio signal, a visual signal, a mechanical cue, an electrical signal to a second processor, or a combination of two or more thereof.

28. The system comprising of claim 27, wherein in response to the indication of failure, closing a valve so as to stop fuel loading.

29. A method for continuously loading fuel into an aluminum-water reactor system, the method comprising:
placing a fuel carriage into a fuel loading position within a transfer tube;
passing a plurality of fuel particles through a fuel inlet of the transfer tube and thereby through a carriage aperture and into an inner carriage cavity of the fuel carriage;
evacuating air from the carriage cavity through a vacuum port;
sliding the fuel carriage along the longitudinal axis of the transfer tube and/or rotating the fuel carriage about the longitudinal axis of the transfer tube into a transfer position by moving the fuel carriage towards an aperture in alignment with a reactor port of the transfer tube; and
exiting the plurality of fuel particles from the fuel carriage through the reactor port.

30. The method of claim 29, comprising rotating the fuel carriage along the longitudinal axis of the transfer tube and/or rotating the fuel carriage about the longitudinal axis of the transfer tube into a reactor loading position such that the carriage aperture faces a reactor port.

31. The method of claim 29, comprising sealing the inner carriage cavity from the fuel inlet and/or the reactor port prior to the evacuating air from the carriage cavity step.

32. The method of claim 29, further comprising moving the fuel carriage along the longitudinal axis of the transfer tube and/or rotating the fuel carriage about the longitudinal axis of the transfer tube with a cam barrel mechanism.

33. The method of any one of claims 29 to 32, further comprising moving the fuel carriage along the longitudinal axis of the transfer tube and/or rotating the fuel carriage about the longitudinal axis of the transfer tube with at least one linear actuator.

34. The method of any one of claims 29 to 33, wherein the vacuum port is located between the fuel inlet port and the reactor port.

35. The method of any one of claims 29 to 34, further comprising maintaining at least one seal between the reactor vessel and an outside environment.

36. The method of any one of claims 29 to 35, wherein the fuel carriage comprises a port extending from the inner cavity through the outer surface, wherein the port is configured to couple with a vacuum port coupling so as to evacuate a fluid within the inner cavity.

37. The method of any one of claims 29 to 36, wherein the fuel carriage comprises a channel extending between the first sealing member and a second sealing member and through the exterior surface for the fuel carriage, wherein the channel is configured to equilibrate to the pressure within the reactor or the pressure of the fuel inlet depending on a location of the fuel carriage within the transfer tube.

38. The method of any one of claims 29 to 37, wherein the fuel carriage comprises a channel extending between the first sealing member and a second sealing member, or between the third sealing member and a fourth sealing member, wherein the channel extends through the exterior surface for the fuel carriage, wherein the channel is configured to equilibrate to the pressure within the reactor or the pressure of the fuel inlet depending on a location of the fuel carriage within the transfer tube.

39. The method of claim 37, wherein the channel is configured to couple with one or more sensors, wherein the one or more sensors are configured to detect the pressure within the channel and the location of the fuel carriage within the transfer tube.

40. The method of claim 39, comprising:
detecting the pressure within the channel and/or and location of the fuel carriage within the transfer tube assembly with a sensor;
transmitting the signal from the sensor to a processor,
comparing the detected pressure within the channel and the location of the fuel carriage within the transfer tube assembly with a desired pressure correlated with the location of the fuel carriage within the transfer tube with the processor;
transmitting a signal from the processor to indicate failure if the detected pressure determined by the sensor at the location is above or below a predetermined desired threshold pressure associated with that correlated location indicating a reduction in effectiveness of the first seal, the second seal, the third seal, and/or the fourth seal.

41. The method of claim 40, wherein the pressure in the reactor vessel is greater than or less than ambient pressure.

42. The method of claim 40, wherein indicating a reduction in effectiveness of the first seal, the second seal, the third seal, and/or the fourth seal comprises transmitting an audio signal, a visual signal, a mechanical cue, an electrical signal to a second processor, or a combination of two or more thereof.

43. The method of claim 40, wherein in response to an indication of failure, closing a valve so as to stop fuel loading.

44. The method of any one of claims 29 to 43, wherein the piston and the carriage body are coaxially aligned along a longitudinal axis of the fuel carriage.

45. The method of claim 44, wherein piston is coupled with an actuator and a guide rail so as to move the piston between a first position and a second position along a longitudinal axis of the fuel loading apparatus.
